(19) United States
(12) Patent Application Publication
(10) Pub. No.: US 2003/0051141 A1
(43) Pub. Date: Mar. 13, 2003

(54) Method and a system for generating and handling documents

(76) Inventor: Marc-Henri Veyrassat, Geneva (CH)

Correspondence Address: JACOBSON HOLMAN PLLC, 400 SEVENTH STREET N.W., SUITE 600, WASHINGTON, DC, 20004, US

(21) Appl. No.: 10/220,600

(22) PCT Filed: Mar. 1, 2001
(86) PCT No.: PCT/EP01/02516

(30) Foreign Application Priority Data
Mar. 1, 2000 (GB) 0004976.6

(51) Int. Cl. H04L 9/00

(52) U.S. Cl. 713/170

(57) ABSTRACT

A method and a system for generating and handling documents. A method and a system for generating documents and for handling them between at least a first and a second party. The system is governed by a supervising authority and provided to encrypt a part of the data forming the document in order to generate an identifier. The identifier being added to the document data.

The invention relates to a method for generating documents and for handling them between at least a first and a second party, said method comprising:

supplying, by said first party, data to a data processing system, governed by a supervising authority, said data comprising a first subset identifying said first party, a second subset identifying a transaction to be performed and a third subset identifying a destination of said transaction;

generating said document comprising said first, second and third subset by encrypting a predetermined part of said data by means of an encryption key assigned by said supervising authority, and storing said document into a memory of said data processing system.

Such a method is known from U.S. Pat. No. 5,748,738. The known method is in particular used for storing at the Authentication Centre valuable documents such as financial and real-estate transaction documents. The data which form the content of the document are furnished via a transfer agent to the Authentication Centre. The latter can verify the identity of the first party which transmits a digitally signed or encrypted document. The Authentication Centre has a separate digital signature capability which enables to authenticate received documents. Upon request of the first and/or second party the Authentication Centre can then provide certified copies of the authenticated documents owned by the Authentication Centre.

A drawback of the known method is that there is generally no direct link between the identifier applied on the document and the content of the document. The identifier is formed by a digital signature applied on the document but which does generally not enable to recompose the document itself. The second user who wants to obtain the stored document can of course have the guarantee of the Authentication Centre but cannot make a check on its own. Such a method is therefor not the most appropriate to use for documents of which the content must change by the nature of the document itself. This is for example the case with customs and fiscal documents which are subject to changes before they reach their destination. The changes must be reflected in the identifier, which must still enable a party to check whether the document has not been falsified.

It is an object of the present invention to realise a method and/or a system for generating and handling documents that enables a more reliable verification of the authenticity of the documents and an improvement of their management.

For this purpose, a method according to the present invention is characterised in that an identifier comprising said predetermined part of said data is formed upon executing said encryption, said identifier being added to said document and stored therewith, and wherein for reading said document by said second party when authorised to decrypt said identifier, said method comprises

reading said identifier from said document;

generating a further document on the basis of said identifier;

comparing said further document with said document from which said identifier is read.

Since the encryption generates an identifier which is added to the document and stored in the memory, only parties having access to the encryption key will be able to decrypt the identifier and in such a manner check the authenticity of the document. If the document should have been falsified, the identifier, which is formed by encrypting a part of the document, will upon decoding immediately expose that falsification. As the encryption key is owned by the supervising authority, the probability that an unauthorised party acquires the encryption key and also modifies the identifier is very low, thus enabling a safe and reliable handling of the documents. Since the document comprising the identifier is generated by the data processing system, a quick and easy management of the documents is possible. By generating a further document on the basis of the identifier, it becomes possible to compare the further document with the available document and verify in such a manner whether or not there is correspondence.

A first preferred embodiment of a method according to the invention is characterised in that said document is a transaction document issued by a competent authority entitled to issue such a transaction document, said method further comprises:

sending by a data processing unit of said first party, a first access request signal towards said competent authority;

sending by a data processing unit of said competent authority of a second access request signal, identifying said competent authority, towards said data processing system of said supervising authority;

checking said second access request signal by said data processing system and generating an access enable signal when said requesting competent authority is recognised as an entitled authority and generating a disable signal when said requesting competent authority is not recognised as an entitled authority;

sending by said data processing system said access enable or disable signal to said data processing unit of said requesting competent authority;

forwarding by said data processing unit of said requesting competent authority of a session identifier signal towards said data processing unit of said first party, upon receipt of an access enable signal.

The competent authority is for example the customs or a bank whereas the supervising authority is the one entitled to manage the production and storage of the documents, including the identifier. Operating with two levels of authorities has the advantage that on the one hand the competent authority has the legal power and on the other hand the supervising authority manages the necessary hardware and software tools. The supervising authority can thus act for different instances which simplifies the transactions and reduces costs, whereas the competent authority keeps the legal supervising power. Since the supervising and the competent authority will operate in close co-operation, the check of the access request enhances the security and enables to easily and quickly identify intruders.

Preferably said data is supplied to said data processing system of said supervising authority upon receipt of said session identifier, and wherein said identifier is formed by using a private encryption key belonging to said supervising authority. The use of a private encryption key provides a high security level without the need for cumbersome operations.

A second preferred embodiment of a method according to the present invention is characterised in that upon comparing said further document with said document from which said identifier is read, said data processing unit of said competent authority generates a further request signal which is sent to said data processing system, said data processing system reading said stored document under control of said further request signal and generating a subsequent document using a public key of said competent authority and which subsequent document is sent to said data processing unit of said competent authority, the latter decrypting said subsequent document using a private encryption key of said competent authority. This enables further verification of the document by requesting the assistance of the supervising authority, which is particularly useful in case that problems would arise due to a non-matching of the document and further documents.

A third preferred embodiment of a method according to the invention is characterised in that said identifier is each time updated when the predetermined part of the data of said document is changed, said updated identifier replacing the identifier stored in said memory. In such a manner, the document and the identifier are updated in parallel enabling a continuous reliable authentication.

Preferably said identifier is formed by a two dimensional barcode. A two dimensional barcode provides a suitable visual presentation of the identifier which can be easily applied.

Preferably said data processing system is remotely located with respect to said first and second party. By locating the data processing system remotely, it can be placed in a room fully controlled by the supervising authority.

The invention also relates to a data processing system enabling the application of the method described here before.

The invention will now be described in more detail with reference to the drawings illustrating a preferred embodiment thereof. In the drawings:

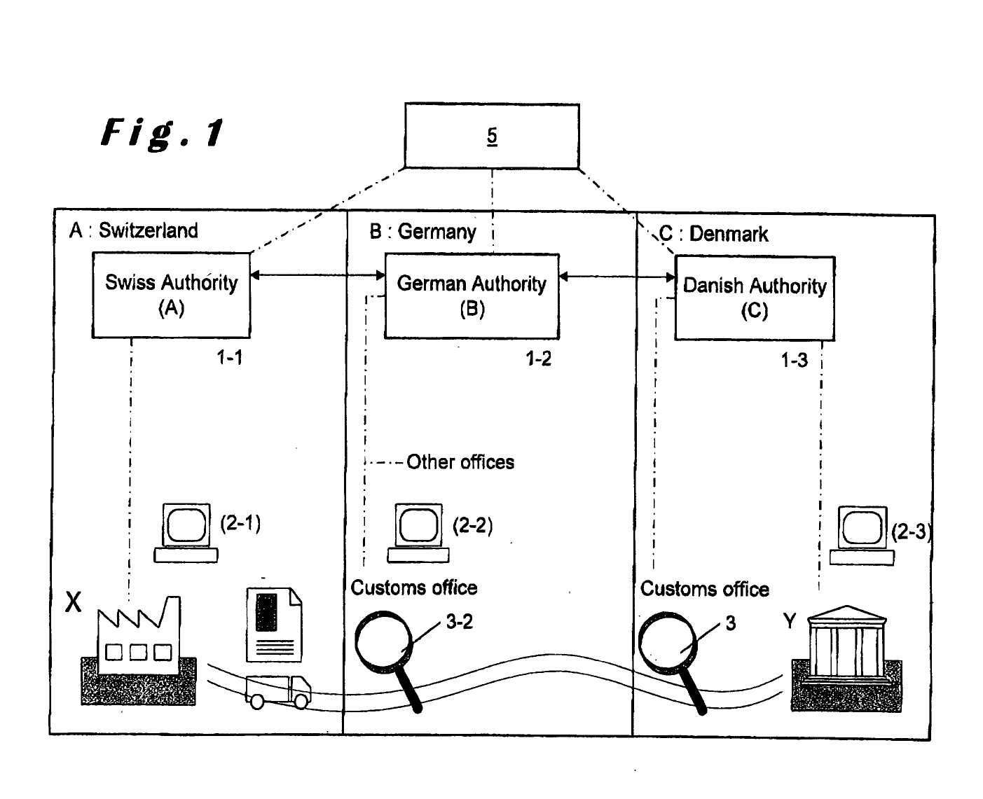

FIG. 1 shows schematically the set-up in which the method according to the present invention is applicable;

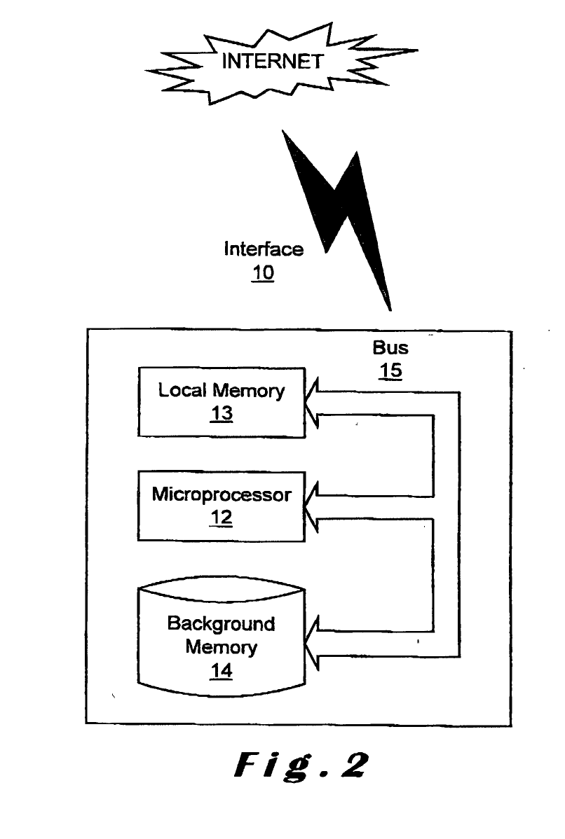

FIG. 2 shows schematically a data processing system according to the invention;

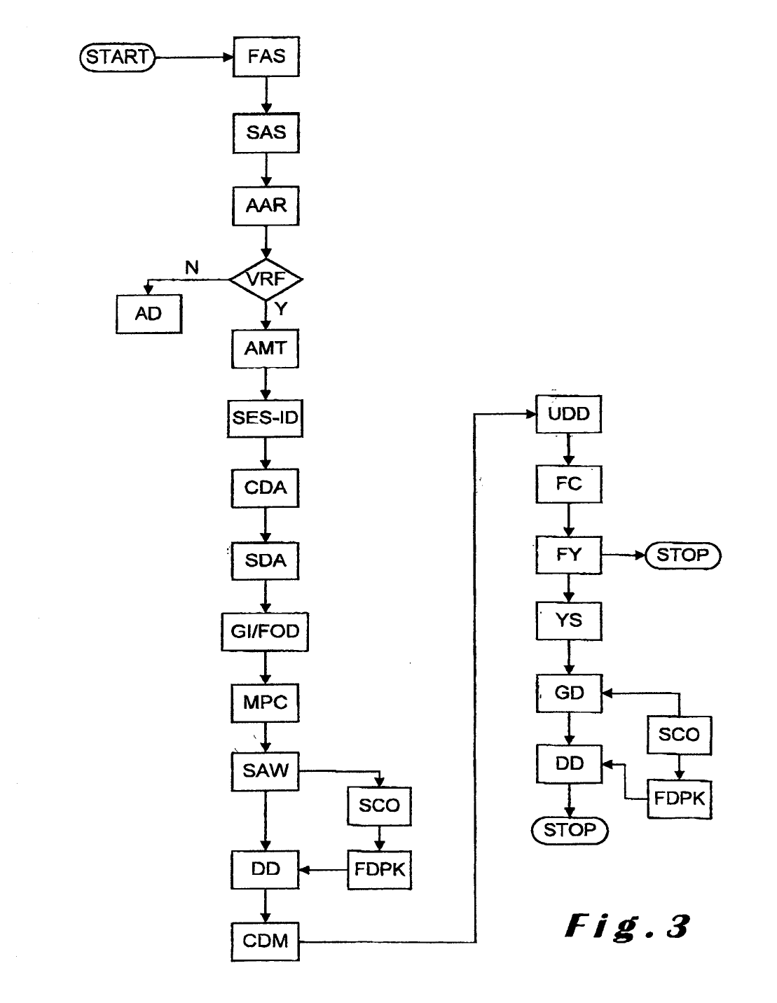

FIG. 3 shows by means of a flow chart the different steps of a method according to the present invention;

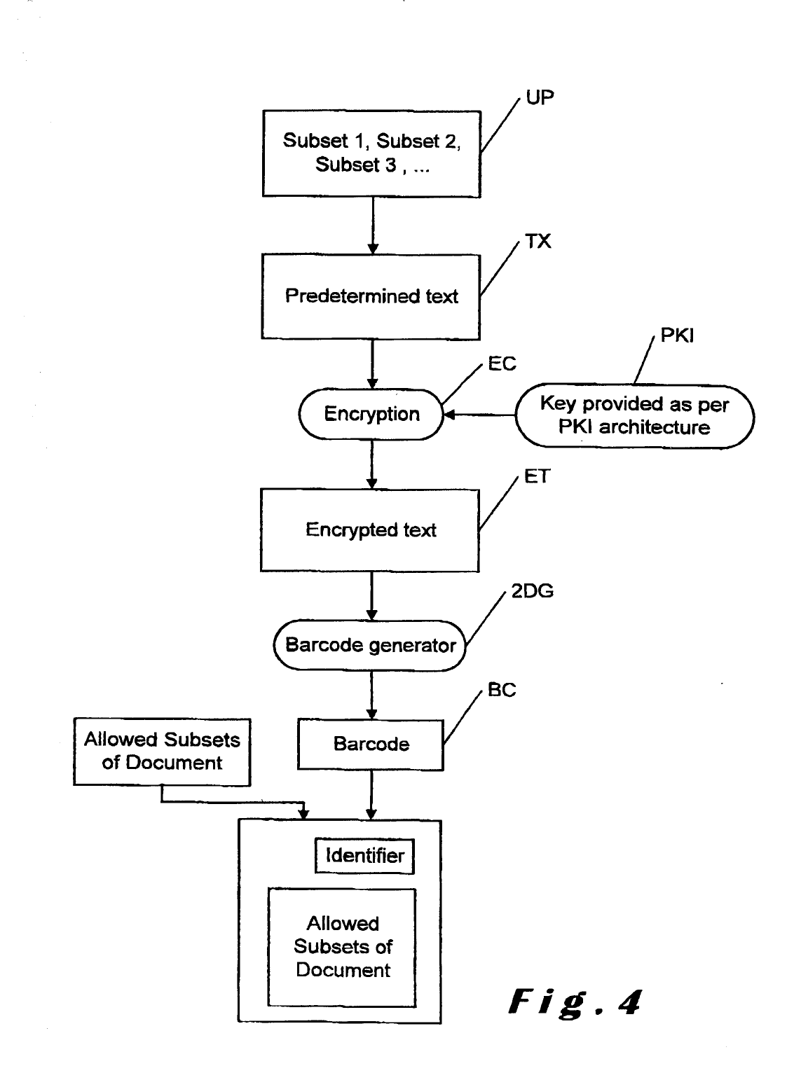

FIG. 4 shows by means of a flow chart the generation of a document; and

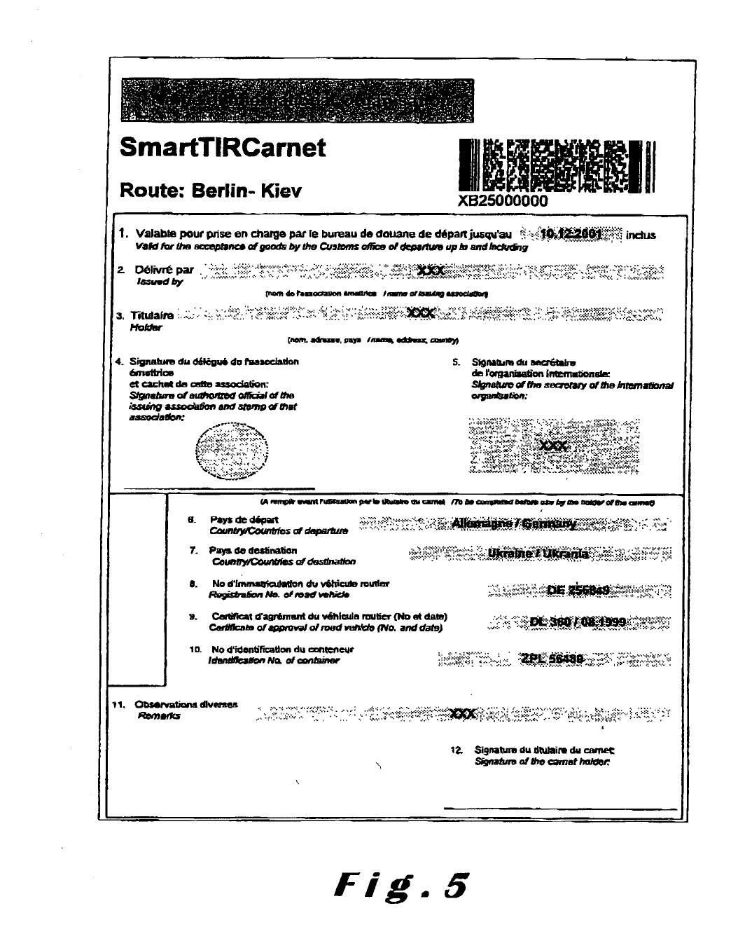

FIG. 5 illustrates an example of a document generated by application of the method according to the present invention.

organisation entitled to issue them, such as for example the customs, the bank authorities or the government. As those documents are generally paper documents, they can be falsified and it is not always easy to recognise that they have been falsified. There is thus a need to provide an adequate tool that enables to easily recognise that a document has been falsified without involving cumbersome and time consuming check procedures.

Referring to FIG. 1, suppose that company X established in country A, for example Switzerland, has sold a good to a company Y established in country C, for example Denmark. The good should be transported by truck from Switzerland over Germany (country B) to Denmark. Custom transaction documents are thus required for transporting the goods. For the sake of clarity and as it is not relevant for the present invention, suppose also that company X has its own transport facilities. Company X will thus need the necessary transport and custom document from the competent Swiss custom authority in order to enable the truck driver to start his trip to Denmark.

According to the present invention, Company X, which is the first party in this transaction, will establish a communication with the data processing unit 1-1 of the Swiss custom authority. As in the present example, the Swiss custom authority is remotely located with respect to company X, the communication will most probably be established via the Internet between the data processing unit (2-1) of company X and the data processing unit 1-1, as this is most convenient. Of course, other communication means are possible such as for example via phone or facsimile, or a person of company X could even go to the custom authority.

In order to obtain such a document, company X has to supply data to the custom authority, which is the second party in this transaction. This data comprises a first subset, identifying the company X, such as for example the name and address of the company, the VAT number etc. The data also comprises a second subset identifying the transaction to be performed, in this example the export of the good, as well as a third subset identifying a destination of the transaction, in this example the name and address of company Y in Denmark. The data could also comprise further parts such as the delivery date, the name of the transport company, the terms of delivery and payment, the value of the goods, guaranties attached to the goods, etc.

Before supplying the data to the custom authority, the company X will first send (FAS) a first access request signal to the custom authority as illustrated in FIG. 3. Upon receipt of such a first access request signal, the custom authority will establish a contact with a supervising authority 5 by sending a second access request signal (SAS). The generation of the first and second access signal is realised by means of the data processing unit 2-1 of the company X and the data processing unit 1-1 of the Swiss custom authority respectively. The supervising authority is for example formed by a company empowered by the governmental authorities to generate the documents and send them, for example via the Internet, to the competent authorities, in the present example the Swiss, German an Danish customs. The supervising authority is the one that owns and controls the necessary tools for producing the documents and store them electronically. For legal security, the supervising authority is of course operating under governmental control.

Referring back to FIG. 3, illustrating the method according to the present invention, once the data processing system of the supervising authority has received the second access request signal, that data processing system will analyse (AAR) if the second request signal has been sent by a registered competent authority. This is for example realised by granting to each competent authority an access key, for example in the form of a smart card comprising an identification code assigned to that competent authority. The competent authority can then send a second access request which is encrypted with its identification code. Since the supervising authority knows the sender and his identification code, it can decrypt the second access request and verify (URF) if the second access request signal was correctly encrypted. If the data processing system of the supervising authority established that the requesting authority is not a registered one, because the access request signal was incorrectly encrypted, the access is denied (AD) causing a disable signal to be generated and no documents will be generated. If on the other hand the requesting competent authority is recognised as a registered one, an access enable signal (AMT) is generated and sent to the requesting competent authority.

The data processing system 6 of the supervising authority 5 comprises for example (see FIG. 2) a bus 15 to which an interface 10, a microprocessor 12, a local memory 13 and a background memory 14 are connected. The data processing system is provided with appropriate software for generating the custom and transport documents comprising the first, second and third subset of data and, if necessary, further data subsets.

Upon receipt of an access enable signal, the data processing unit 1-1 of the registered competent authority will now generate a session identifier signal (SES-ID) and send it to the data processing unit 2-1 of the company X. Upon receipt of the session identifier, the company X will collect its data (CDA) and using that session identifier, send (SDA) that data to the data processing unit of the competent authority or even directly to the supervising authority.

Upon receipt of the data necessary to form the document, the data processing system of the supervising authority will preferably temporarily store them in the local memory 13 and generate an identifier. For this purpose, an encryption key, which is assigned by the supervising authority, is stored in the memory of the data processing system. Since the encryption key is assigned and controlled by the supervising authority, the latter also controls the encryption process performed by using that key, thus providing a reliable solution which cannot easily be falsified.

In order to form the identifier (see FIG. 4), the data processing system uses a predetermined part of the supplied data (UP), for example the names of the companies X and Y and the second subset and forms a text (TX) therewith. Then it encrypts (EC) that part using the encryption key (PKI). The identifier is added to the generated document in order to form an entity which is stored into the memory, preferably the background memory.

The generation of the identifier (GI) is preferably realised by using a private encryption key (PKI) owned by the supervising authority in order to enable to verify the authenticity of the generated document. The latter being then formed (ET; FOD) by adding the identifier to the data. The document is saved in text form in the database or background memory (14) and preferably also in encrypted form. Once the document comprising its identifier is generated, it is sent (MPC) to the company X either directly or via the competent authority.

A paper copy of the generated document comprising the identifier can then be handed over to company X in such a manner that the truck driver can take it with him. FIG. 5 shows an example of such a document with the identifier printed thereon. In this example, the identifier is formed (2DG) by a two dimensional (2D) barcode printed at the upper right corner of the document. It will however be clear that other presentations of the identifier are possible such as for example a cryptogram, a string of letters and numbers, a colour combination. If the document is for example an optical disc, the identifier could be formed by a data string burnt into a disc at a predetermined location.

The means for generating the documents are preferably provided to generate the document including the identifier with a resolution printing quality enabling a facsimile and/or e-mail transmission. As the document must be transmitted from the supervising authority to the company X or to the competent authority, it is necessary that a good printing quality is achieved, in particular if facsimile transmission is required. In such a manner, reading the document will not be a problem.

The document has preferably also a predetermined lay-out, which is for example obtained by storing a template in the memory. The predetermined lay-outs enable to recognise easily the document.

As illustrated in FIG. 1, the data processing unit 1-1 of the competent authority in country A is provided to communicate with an analogous data processing unit 1-2 in country B and 1-3 in country C. That communication is realised in a usual manner such as for example the Internet or other communication means. In such a manner, the competent authorities of countries B and C can communicate with each other. Moreover, as the data processing units 1-1, 1-2 and 1-3 are all in communication, for example via the Internet, with the supervising data processing system 6, they get access to the documents stored in background memory 14. It should be noted that the access to the documents stored in the background memory of the supervising authority could be selective depending on what is needed by the requesting party. Some data may for example only be accessible by the custom authorities, other may be common to everybody. Companies may have for example a limited access only to their own documents.

The competent authorities have local terminals 3, connected with their respective data processing units 1, preferably equipped with scanners, provided for reading the identifier and decoding the latter. The competent authorities could also be equipped with mobile scanners in order to control all over the country.

Suppose now that the truck of company X, having on board the documents and goods, reaches the Swiss/German border. The driver furnishes the document identifying the goods to be transported to Denmark to the German customer officer. The latter will scan (SAN) or otherwise read the identifier on the document and generate a further document based on the identifier. For this purpose, the information read from the identifier is supplied to the local terminal 3-2 where the identifier is decrypted using the public encryption key provided by the supervising authority. For further verification, the custom authority could even request a copy of the document at the supervising authority which might be necessary when the authenticity of the document can not be verified. For this purpose, the data processing unit of the competent authority generates a further request signal which is sent to the data processing systems of the supervising authority. Upon receipt of such a further request signal, the data processing system will read (SCO) the stored document identified in the further request signal and transmit a subsequent document, formed by a copy of the read document, to the custom authority. Therefore the supervising authority data processing system will encrypt that document by using the requesting custom authority's public key.

Upon receipt of such a subsequent document, the data processing unit of the custom authority will decrypt the received subsequent document using its private key (FDPK).

The generated further or subsequent document is either displayed on a monitor or printed (DD). The custom officer can then compare (CDM) the further or subsequent document with the one supplied by the truck driver and verify if they correspond. Since the identifier was generated with data from the original document, that data must be reproducible upon decrypting the identifier. If however the document has been falsified, the custom officer will immediately observe that the document provided by the driver and the further document do not match. Appropriate measures can then be taken (TAM).

The customs can also add their country's specific information to the document. Therefore they will encrypt the document using a public key of the supervising authority and send the encrypted data to the supervising authority. Upon receipt of the latter, the data processing system of the supervising authority will decrypt (UDD) the received data sent by the customs using the private decryption key of the supervising authority. The document will be updated and stored in the database with the country's specific data. This helps to track where the goods are.

If the company Y would like to check the document upon receipt of the goods, they could get into contact with the competent authority in Denmark and ask for checking whether the identifier and the document are authentic. The company or customs could also check whether the customs duty has been paid by company X.

If the document needs to be updated, for example if a particular authorisation is needed from the customs, then the custom officer will use his local terminal 3 to call the data processing system and enter the updated information. The data processing system will update the document and create an updated identifier if the update affects the predetermined part used to generate the identifier. The updated document and its updated identifier will then overrule the original one, stored in the memory. A new printed document, comprising the updated identifier, will be issued.

The same process as described here before and which occurred at the Swiss customs could also be realised when the goods arrive (FC) at the German/Danish border and/or at company Y (FY). If everything is all right then the process stops. If not, the German or Danish customs (YS) can scan the identifier applied on the document received with the goods and start the verification process. Moreover, the latter customs decrypt (GD) the identifier using the public key of the supervising authority for checking the authenticity. For further verification they can also request a copy at the supervising authority. The operations SCO, FDPR, and DD are then repeated.

Besides the usual data, the document could also comprise a guarantee issued by a competent authority. In the latter case, that competent authority could also have an access to the data processing system and receive the necessary data before the document is generated. If that authority grants the guarantee, it will communicate it to the data processing system so that this information can be added to the document.

1. A method for generating documents and for handling them between at least a first and a second party, said method comprising
supplying, by said first party, data to a data processing system, governed by a supervising authority, said data comprising a first subset identifying said first party, a second subset identifying a transaction to be performed and a third subset identifying a destination of said transaction;
generating said document comprising said first, second and third subset by encrypting a predetermined part of said data by means of an encryption key assigned by said supervising authority, and storing said document into a memory of said data processing system;
characterised in that an identifier comprising said predetermined part of said data is formed upon executing said encryption, said identifier being added to said document and stored therewith, and wherein for reading said document by said second party when authorised to decrypt said identifier, said method comprises:
reading said identifier from said document;
generating a further document on the basis of said identifier;
comparing said further document with said document from which said identifier is read.

2. A method as claimed in claim 1, characterised in that said document is a transaction document issued by a competent authority entitled to issue such a transaction document, said method further comprises:
sending by a data processing unit of said first party, a first access request signal towards said competent authority;
sending by a data processing unit of said competent authority of a second access request signal, identifying said competent authority, towards said data processing system of said supervising authority;
checking said second access request by said data processing system and generating an access enable signal, when said requesting competent authority is recognised as an entitled authority and generating a disable signal, when said requesting competent authority is not recognised as an entitled authority;
sending by said data processing system said access enable or disable signal to said data processing unit of said requesting competent authority;
forwarding by said data processing unit of said requesting competent authority of a session identifier signal towards said data processing unit of said first party, upon receipt of an access enable signal.

3. A method as claimed in claim 2, characterised in that upon receipt of said session identifier signal, said data is supplied to said data processing system of said supervising authority, and wherein said identifier is formed by using a private encryption key belonging to said supervising authority.

4. A method as claimed in claim 3, characterised in that upon generating said further document, said identifier is decrypted by using a public encryption key belonging to said supervising authority.

5. A method as claimed in claim 3 or 4, characterised in that upon comparing said further document with said document from which said identifier is read, said data processing unit of said competent authority generates a further request signal which is sent to said data processing system, said data processing system reading said stored document under control of said further request signal and generating a subsequent document using a public key of said competent authority and which subsequent document is sent to said data processing unit of said competent authority, the latter decrypting said subsequent document using a private encryption key of said competent authority.

6. A method as claimed in claim 1 or 2, characterised in that said identifier is each time updated when the predetermined part of the data of said document is changed, said updated identifier replacing the identifier stored in said memory.

7. A method as claimed in claim 5 and 6 characterised in that said updated identifier is generated by using a public key of said supervising authority.

8. A method as claimed in claim 7, characterised in that upon updating said identifier, said data processing system decrypts data received from said competent authority by using the private key of the latter.

9. A method as claimed in anyone of the claims 1 to 8, characterised in that said identifier is formed by a 2 dimensional barcode.

10. A method as claimed in anyone of the claims 1 to 9, characterised in that said data processing system is remotely located with respect to said first and second party.

11. A data processing system provided for generating and handling documents, said data processing system comprising an input provided for receiving from a first party, document data, having a first subset, identifying said first party supplying said document data, a second subset, identifying a transaction to be performed and a third subset, identifying a destination of said transaction, said data processing system further comprising document generation means connected to said input and provided for generating said document with said document data, said data processing system comprises encryption means having a key input provided to input an encryption key assigned by a supervising authority, said encryption means being connected to said document generating means, characterised in that said encryption means are provided for generating an identifier by encrypting a predetermined part of said document data with said encryption key and annexing said identifier to said document, and wherein said document generation means are further provided for generating a further document on the basis of said identifier and for comparing said further document with said document.

12. A data processing system as claimed in claim 11, characterised in that it comprises a reading member provided for reading said identifier, said reading member comprising, for decrypting said identifier, said reading member being further provided for generating said document upon reading said identifier.

13. A data processing system as claimed in anyone of the claims 11 or 12, characterised in that said document generating means are provided to generate a document with a resolution printing quality enabling a facsimile and/or e-mail transmission of the document.

14. A data processing system as claimed in anyone of the claims 11 to 13, characterised in that said document generating means are provided for storing predetermined document lay-outs.

15. A method as claimed in anyone of the claims 1 to 10, characterised in that said document is transmitted to a third party competent to assign a guarantee to the transaction to be performed, said third party being entitled to assign a fourth subset to said data when assigning said guarantee, said generating of said document being disabled if said fourth subset is not available.
